(19) United States
(12) Patent Application Publication
(10) Pub. No.: US 2008/0137243 A1
(43) Pub. Date: Jun. 12, 2008

(54) ESD PROTECTION CIRCUIT FOR AN INTEGRATED CIRCUIT WITH A NEGATIVE VOLTAGE INPUT TERMINAL

(75) Inventors: TA-YUNG YANG, MILPITAS (US); CHIH-FENG HUANG, HSINCHU COUNTY (TW)

Correspondence Address: J C PATENTS, INC., 4 VENTURE, SUITE 250, IRVINE, CA, 92618, US

(73) Assignee: SYSTEM GENERAL CORP., TAIPEI HSIEN (TW)

(21) Appl. No.: 11/608,120

(22) Filed: Dec. 7, 2006

(51) Int. Cl. H02H 9/04

(52) U.S. Cl. 361/56

(57) ABSTRACT

An ESD protection circuit is provided for protecting an integrated circuit from ESD damage and for protecting lightening surge. The ESD protection circuit includes a first snapback device and a second snapback device. The first snapback device is connected to a first terminal having a negative voltage of the integrated circuit during the operation of the integrated circuit. The first snapback device includes an anode coupled to the first terminal of the integrated circuit. The cathode of the first snapback device is coupled to a VCC terminal of the integrated circuit. The second snapback device has a cathode coupled to the VCC terminal. The anode of the second snapback device is connected to the ground of the integrated circuit. The snapback devices operate as silicon-controlled rectifiers (SCR) to protect the integrated circuit.

### BACKGROUND OF THE INVENTION

1. Field of the Invention

The present invention relates to a protection circuit. More particularly, the present invention relates to a protection circuit of an integrated circuit.

2. Description of Related Art

An ESD protection circuit is typically used in an integrated circuit to protect the integrated circuit from ESD (electric static discharge) and is typically used to lighten surge protection. Referring to FIG. 1, a silicon-controlled rectifier (SCR) 20 is connected to a circuit 10 to be protected in parallel. When a surge voltage is introduced into the circuit 10, the SCR 20 clamps the voltage under the absolute maximum value to avoid the circuit 10 from breakdown due to over-voltage. However, this ESD protection circuit is not workable if a negative voltage is applied to the I/O terminal during the normal operation. A substrate current will be drawn from the I/O terminal in response to the negative voltage, which will cause an abnormal operation of the circuit 10. This shortcoming is the main object of the present invention to overcome.

### SUMMARY OF THE INVENTION

The present invention provides an ESD protection circuit for protecting an integrated circuit from ESD damage. The ESD protection circuit includes a first snapback device connected to a first terminal for sustaining a negative input voltage during the operation of the integrated circuit. The first snapback device includes an anode coupled to the first terminal of the integrated circuit. The cathode of the first snapback device is coupled to a VCC terminal of the integrated circuit. A second snapback device has a cathode coupled to the VCC terminal. The anode of the second snapback device is connected to the ground of the integrated circuit. The snapback device operates as a silicon-controlled rectifier (SCR). The voltage of the device will be snapped back to absorb the surge voltage when the p-n junction of the device is broken down. Thus, the ESD protection circuit protects the integrated circuit from ESD damage. Furthermore, an anode of a first diode is connected to a second terminal of the integrated circuit. No negative voltage is input to the second terminal during the normal operation of the integrated circuit. The cathode of the first diode is coupled to the VCC terminal. A cathode of a second diode is connected to the second terminal (such as I/O terminal). The anode of the second diode is coupled to the ground. Advantageously, the ESD protection circuit of this invention has no p-n junction device connected from the first terminal to the ground, which allows the negative voltage input during the operation of the integrated circuit. It is to be understood that both the foregoing general description and the following detailed description are exemplary, and are intended to provide further explanation of the invention as claimed.

### BRIEF DESCRIPTION OF THE DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a traditional circuit including an ESD protection device.

FIG. 2 is an ESD protection circuit for a negative voltage input terminal of an integrated circuit in accordance with present invention.

FIG. 3 is an equivalent circuit of the snapback device in accordance with present invention.

FIG. 4 shows a cross-section diagram of the snapback device in accordance with present invention.

FIG. 5 shows a voltage-to-current characteristic of the snapback device in accordance with present invention.

FIG. 6A˜6D show ESD protection flows in response to various input surges.

### DESCRIPTION OF THE PREFERRED EMBODIMENTS

FIG. 2 is a preferred embodiment of an ESD protection circuit of an integrated circuit 200. A snapback device 50 is connected to a terminal IN for receiving a negative voltage input during the normal operation of the integrated circuit 200. The snapback device 50 includes an anode (A) coupled to the terminal IN of the integrated circuit 200. The cathode (K) of the snapback device 50 is coupled to a VCC terminal of the integrated circuit 200. Another snapback device 60 has a cathode (K) coupled to the VCC terminal. The anode (A) of the snapback device 60 is connected to the ground GND of the integrated circuit 200. The snapback devices 50 and 60 operate as a silicon-controlled rectifier (SCR). The voltage of the snapback devices 50 and 60 will be snapped back to absorb an input surge when the p-n junction of the device is broken down. Thus, the snapback devices 50 and 60 can protect the integrated circuit 200 from ESD damage. Furthermore, an anode of a diode 70 is connected to an I/O terminal of the integrated circuit. No negative voltage is input to an I/O terminal during the operation of the integrated circuit 200. The cathode of the diode 70 is coupled to the VCC terminal. A cathode of a diode 75 is connected to the I/O terminal. The anode of the diode 75 is coupled to the ground GND.

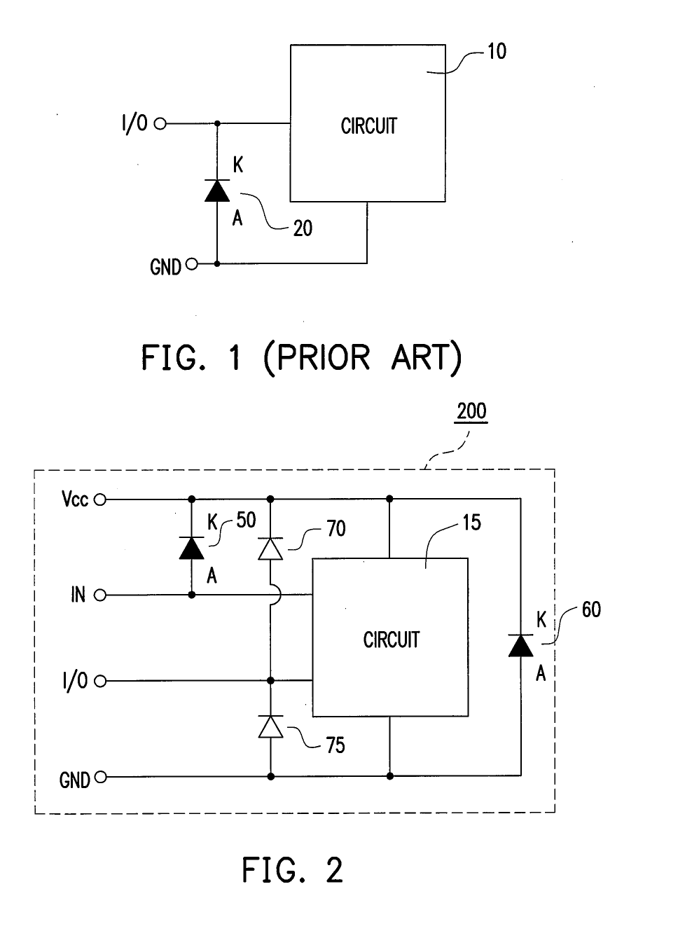

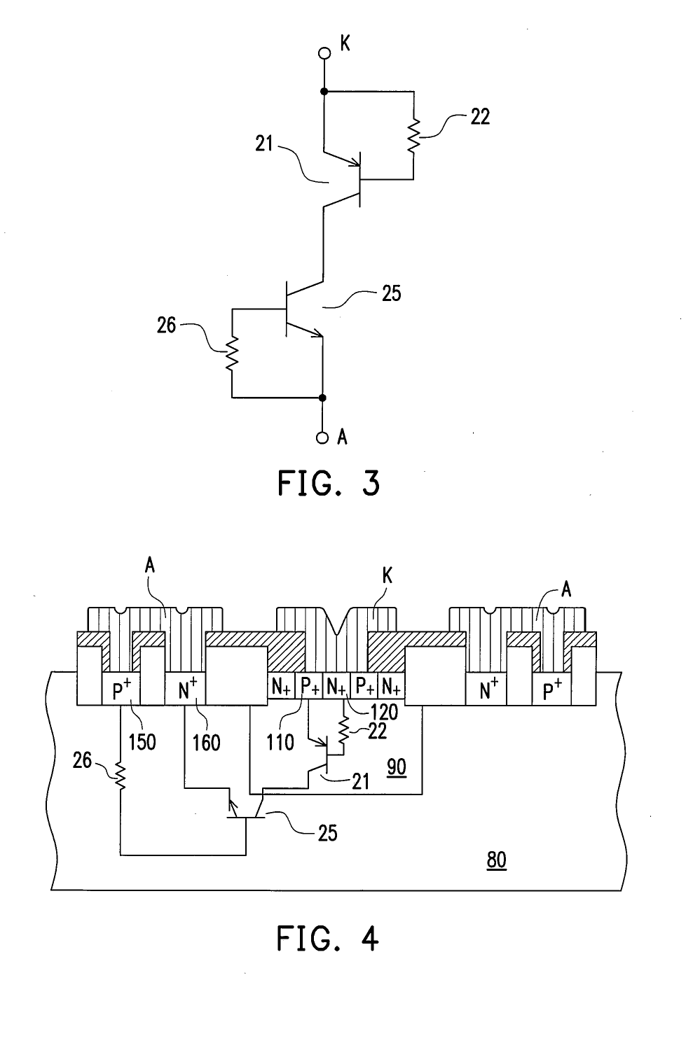

FIG. 3 is an equivalent circuit of the snapback devices 50 and 60, as shown in FIG. 1. It includes a parasitic p-n-p bipolar transistor 21 and a parasitic n-p-n bipolar transistor 25. The emitter of the parasitic p-n-p bipolar transistor 21 is connected to the cathode (K) of the snapback device. The base of the parasitic p-n-p bipolar transistor 21 is coupled to the cathode (K) of the snapback device through a parasitic resistance 22. The emitter of the parasitic n-p-n bipolar transistor 25 is connected to the anode (A) of the snapback device. The base of the parasitic. n-p-n bipolar transistor 25 is coupled to the anode (A) of the snapback device via a parasitic resistance 26. The collector of the parasitic p-n-p bipolar transistor 21 is coupled to the collector of the parasitic n-p-n bipolar transistor 25.

FIG. 4 shows a cross-section diagram of the snapback device 50 and 60. The emitter of the parasitic p-n-p bipolar transistor 21 is connected to a p+ diffusion 110 in an N-well 90. The base of the parasitic p-n-p bipolar transistor 21 is coupled to an n+diffusion 120 through a parasitic resistance 22 of the N-well 90. The collector of the parasitic p-n-p bipolar transistor 21 is connected to a p-substrate 80. The emitter of the parasitic n-p-n bipolar transistor 25 is connected to an n+ diffusion 160 in the P-substrate 80. The base of the parasitic n-p-n bipolar transistor 25 is coupled to a p+ diffusion 150 through a parasitic resistance 26 of the p-substrate 80. The collector of the parasitic n-p-n bipolar transistor 25 is connected to the N-well 90.

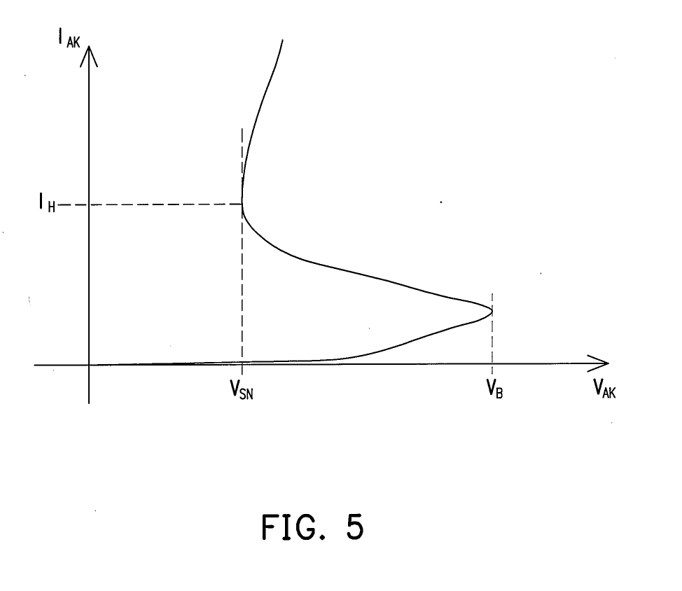

FIG. 5 shows a voltage-to-current characteristic of the snapback devices 50 and 60, as shown in FIG.2. In the snapback device, an anode-to-cathode voltage V_{AK}, an anode-to-cathode current I_{AK} and an anode-to-cathode impedance are respectively defined as a voltage difference, a current and impedance between the anode terminal and the cathode terminal of the snapback device. When the anode-to-cathode voltage V_{AK} of the snapback device is higher than a breakdown voltage V_{B}, the anode-to-cathode impedance of the snapback device will become negative in response to the increase of the anode-to-cathode current I_{AK}. The anode-to-cathode impedance will not return to the positive impedance until a snapback voltage V_{SN} is reached. The leakage current of the parasitic p-n-p bipolar transistor 21 and the parasitic n-p-n bipolar transistor 25, as shown in FIG.3, contributes to the positive feedback phenomenon. The leakage current will be significantly increased once the p-n junction of snapback device breaks down. The leakage current associated with the parasitic resistances 22 and 26 achieves snapback.

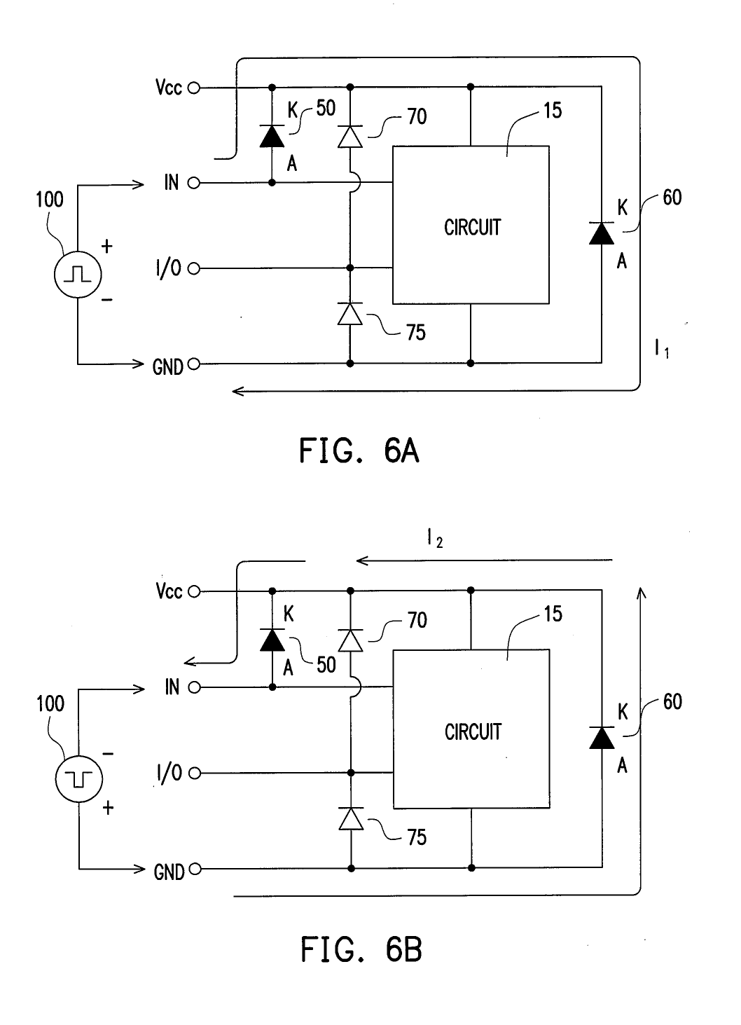

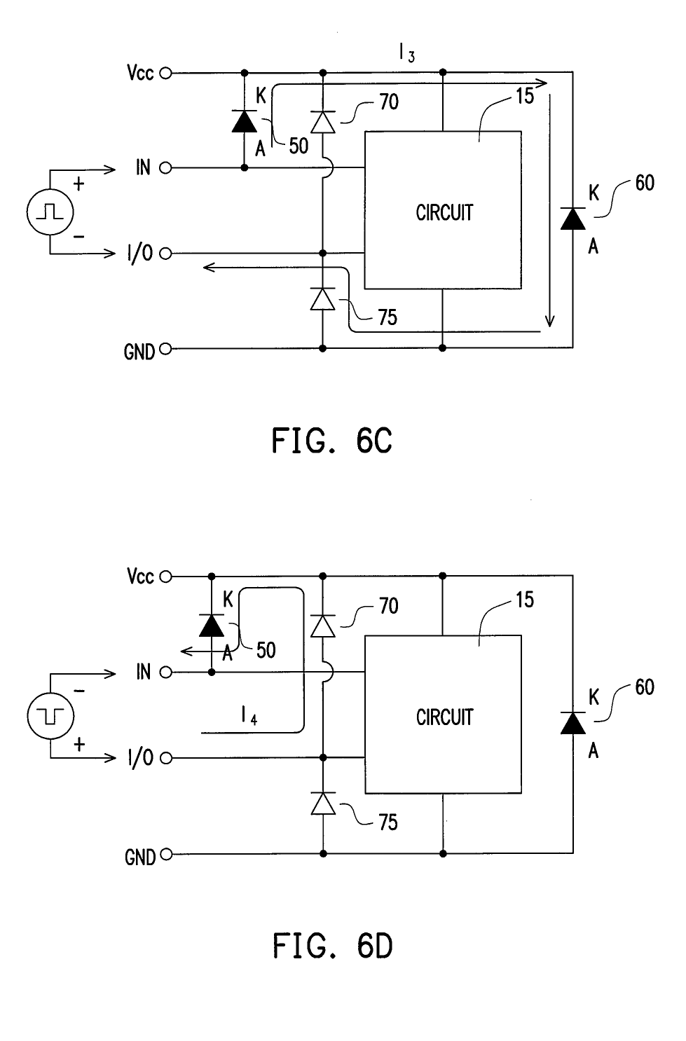

FIG. 6A˜6D show ESD protection flows in response to various input surges. As shown in FIG. 6A, a positive surge voltage is applied to the terminal IN and the ground GND. The snapback device 50 will be forward conducted. The snapback device 60 will break down and snap back to clamp the voltage in between the terminal IN and the ground GND. FIG. 6B shows a negative surge voltage is applied to the terminal IN and the ground GND. The snapback device 60 will be forward conducted. The snapback device 50 will break down and snap back to clamp the voltage in between the terminal IN and the ground GND. As shown in FIG. 6C, a positive surge voltage is applied to the terminal IN and the I/O terminal. The snapback device 50 and the diode 75 will be forward conducted. The snapback device 60 will break down and snap back to clamp the voltage in between the terminal IN and the I/O terminal. FIG. 6D shows a negative surge voltage is applied to the terminal IN and the I/O terminal. The diode 70 will be forward conducted. The snapback device 50 will break down and snap back to clamp the voltage in between the terminal IN and the I/O terminal.

Advantageously, the ESD protection circuit of this invention has no p-n junction device connected from the terminal IN to the ground GND, which allows the negative voltage to be input during the operation of the integrated circuit. It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A ESD protection circuit for an integrated circuit, comprising:
a first snapback device, having an anode coupled to a first terminal of the integrated circuit and a cathode coupled to a VCC terminal of the integrated circuit; and
a second snapback device, having a cathode coupled to the VCC terminal and an anode coupled to a ground of the integrated circuit;
wherein the first terminal has a negative input voltage during an operation of the integrated circuit.

2. The ESD protection circuit as claimed in claim 1, further comprising:
a first diode, having an anode coupled to a second terminal of the integrated circuit and a cathode coupled to the VCC terminal of the integrated circuit; and
a second diode, having a cathode coupled to the second terminal of the integrated circuit and an anode coupled to the ground.

3. The ESD protection circuit as claimed in claim 1, wherein the first and the second snapback devices operate as silicon-controlled rectifiers (SCR).

4. The ESD protection circuit as claimed in claim 1, wherein each of the first and second snapback devices comprises:
a parasitic p-n-p bipolar transistor, disposed in a N-well; and
a parasitic n-p-n bipolar transistor, disposed in a P-substrate;
wherein an emitter and a base of the parasitic p-n-p bipolar transistor are coupled to the cathode of each of the first and second snapback devices respectively; a base and an emitter of the parasitic n-p-n bipolar transistor are coupled to the anode of each of the first and second snapback device respectively; and a collector of the parasitic p-n-p bipolar transistor is coupled to a collector of the parasitic n-p-n bipolar transistor.

5. The ESD protection circuit as claimed in claim 4, wherein the emitter of the parasitic p-n-p bipolar transistor is connected to a first p+ diffusion in the N-well.

6. The ESD protection circuit as claimed in claim 4, wherein the base of the parasitic p-n-p bipolar transistor is coupled to a first n+ diffusion through a parasitic resistance of the N-well.

7. The ESD protection circuit as claimed in claim 4, wherein the collector of the parasitic p-n-p bipolar transistor is connected to the p-substrate.

8. The ESD protection circuit as claimed in claim 4, wherein the emitter of the parasitic n-p-n bipolar transistor is connected to a second n+ diffusion in the P-substrate.

9. The ESD protection circuit as claimed in claim 4, wherein the base of the parasitic n-p-n bipolar transistor is coupled to a second p+ diffusion through a parasitic resistance of the p-substrate.

10. The ESD protection circuit as claimed in claim 4, wherein the collector of the parasitic n-p-n bipolar transistor is connected to the N-well.
